(19) United States
(12) Patent Application Publication
(10) Pub. No.: US 2003/0101262 A1
(43) Pub. Date: May 29, 2003

(54) Method and system for scheduling the maintenance of remotely monitored devices

(75) Inventor: Bryan W. Godwin, Round Rock, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: Isochron Data Corporation

(21) Appl. No.: 10/304,603

(22) Filed: Nov. 26, 2002

Related U.S. Application Data
(60) Provisional application No. 60/334,015, filed on Nov. 27, 2001.

(51) Int. Cl. G06F 15/173

(52) U.S. Cl. 709/224

(57) ABSTRACT

A system and method for transitioning remotely monitored devices, including point of sale devices such as vending machines, between maintenance states is disclosed. The system and method provide that operational data for a remotely monitored device may be reviewed such that a determination may be made as to the device's ability to continue operating on an as-needed maintenance schedule. Any errors or discrepancies detected in the operational data may result in the remote device being placed on a defined maintenance schedule. Should the operational data indicate that the remote device is performing within desirable parameters, the remote device may remain on or be transitioned back to as-needed maintenance scheduling. The system and method generally ensure that remote devices in a distributed asset system are properly maintained in an efficient, cost effective manner.

### CROSS REFERENCE TO RELATED APPLICATIONS

This application is related to U.S. patent application Ser. No. 09/267,254, filed Mar. 12, 1999, and entitled “Remote Data Acquisition and Transmission System and Method”, now issued as U.S. Pat. No. 6,457,038.

This application is related to co-pending U.S. Provisional Application Serial No. 60/334,016 filed Nov. 27, 2001 (Attorney Docket No. 064814.0195) entitled Method and System for Predicting the Service Needs of Remote Point of Sale Devices now filed as U.S. application Ser. No. ______ filed ______ now U.S. Pat. No. ______.

### RELATED APPLICATION

This application claims the benefit, under 35 U.S.C. §119(e), of previously filed provisional application Method and System for Scheduling the Maintenance of Remotely Monitored Devices, Serial No. 60/334,015, filed Nov. 27, 2001

### TECHNICAL FIELD

The present invention relates generally to distributed asset management and, more particularly, to a scheduling system for ensuring remotely monitored equipment and industrial machines, such as point of sale devices, are maintained.

### BACKGROUND OF THE INVENTION

In most distributed asset systems, the time lost traveling between distant assets can result in significant amounts of unproductive time and money expenditures. Today, in an effort to keep all of their assets operational, many distributed asset system operators schedule routine visits to each of their many assets, regardless of need. In doing so, the distributed asset system operator commits to spending large sums of money to send an employee to each asset on a particular route regardless of the asset's maintenance needs.

In recent years, more effective distributed asset systems have been developed that operators to remotely monitor their assets. Remote monitoring of distributed assets typically allows operators to communicate with individual devices. During communication, an operator may determine whether a particular device is in need of the type of attention that requires a technician to visit the particular device's site or whether the asset may be remotely reset.

While the ability to remotely monitor a system of distributed assets has its advantages, it also presents some limitations. For example, it is foreseeable that a distributed asset system operator may at times be unable to communicate with a particular device which may subsequently result in the disappearance of the device from the operator's maintenance schedule. Similarly, as many of the systems used to remotely monitor distributed assets employ wireless technology, it is foreseeable that a particular device may transmit correct information to its operator only to have the wireless transmission medium garble or otherwise corrupt the information before it is received and read. As a result, the garbled data may mislead the distributed asset operator into thinking that the particular device is operating appropriately or, alternatively, malfunctioning.

### SUMMARY OF THE INVENTION

In accordance with teachings of the present invention, a method for transitioning a maintenance schedule for a remotely monitored asset or device, such as a vending machine, between as-needed maintenance scheduling and defined maintenance scheduling is provided. According to teachings of the present invention, the method preferably includes maintaining historical operational data for the remotely monitored asset or device. In addition, the method preferably verifies receipt of valid operational data for the remotely monitored asset or device as well as verifies that current operational data is consistent with a predefined period of historical operational data for the remotely monitored asset or device. After examining the current operational data and the historical operational data to detect the occurrence of at least one triggering event, the method preferably transitions the remotely monitored asset or device from as-needed maintenance scheduling to defined maintenance scheduling in response to at least one failure in verification or transitions the remotely monitored asset or device from defined maintenance scheduling to as-needed maintenance scheduling in response to success in verification and the detection of at least one triggering event.

In a further embodiment, a system for scheduling the maintenance of remote devices is provided. The system preferably includes a wide area network, at least one remote device operably coupled to the wide area network and a network operations center operably coupled to the wide area network operable to monitor the at least one remote device via the wide area network. The at least one remote device is preferably operable to communicate operational data to the network operations center. The network operations center is preferably operable to place the remote device on a defined maintenance schedule in response to a determination that current and historical operational data for the remote device is inconsistent and that operational data for the remote device is invalid or to place the remote device on an as-needed maintenance schedule in response to a determination that the current and historical operational data for the remote device is consistent and that the operational data for the remote device is valid.

In yet a further embodiment, a method for ensuring the maintenance scheduling of remotely located point of sale devices is provided. The method preferably includes identifying a current maintenance schedule for a remotely located point of sale device and examining a data file including information indicative of a current operating status of the remotely located point of sale device to verify validity of the data file, consistency of the current operating status with a history of the remotely located point of sale device's operating characteristics and to identify at least one triggering event. Upon examination of the data file, the method preferably continues by transitioning, if the current maintenance schedule for the remotely located point of sale device is an as-needed maintenance schedule, the remotely located point of sale device from the as-needed maintenance schedule to a defined maintenance schedule in response to a failure in verification of the data file. In addition, if the current maintenance schedule for the remotely located point of sale device is on an as-needed maintenance schedule, the method preferably continues by transitioning the remotely located point of sale device from the as-needed maintenance schedule to a defined maintenance schedule in response to a failure in identification of at least one triggering event in the data file. However, if the current maintenance schedule for the remotely located point of sale device is a defined maintenance schedule, the method preferably transitions the remotely located point of sale device to an as-needed maintenance schedule in response to verification of data file validity and consistency and identification of at least one triggering event

One technical advantage provided by the present invention is the reduced likelihood that assets will be dropped from maintenance schedules due to communication link failures.

An additional technical advantage provided by the present invention is a distributed, auto-correcting and self-diagnosing network with graceful performance degradation in events of single point failures at remote sites.

The present invention further provides the technical advantage of automatically switching the maintenance scheduling of distributed assets between as-needed maintenance scheduling and defined maintenance scheduling.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 is a schematic drawing illustrating a functional block diagram of one embodiment of a remote data acquisition system for remote devices according to teachings of the present invention; and

FIG. 2 is a flow chart illustrating one method for altering the maintenance scheduling of remotely monitored assets or devices according to teachings of the present invention.

### DETAILED DESCRIPTION OF THE INVENTION

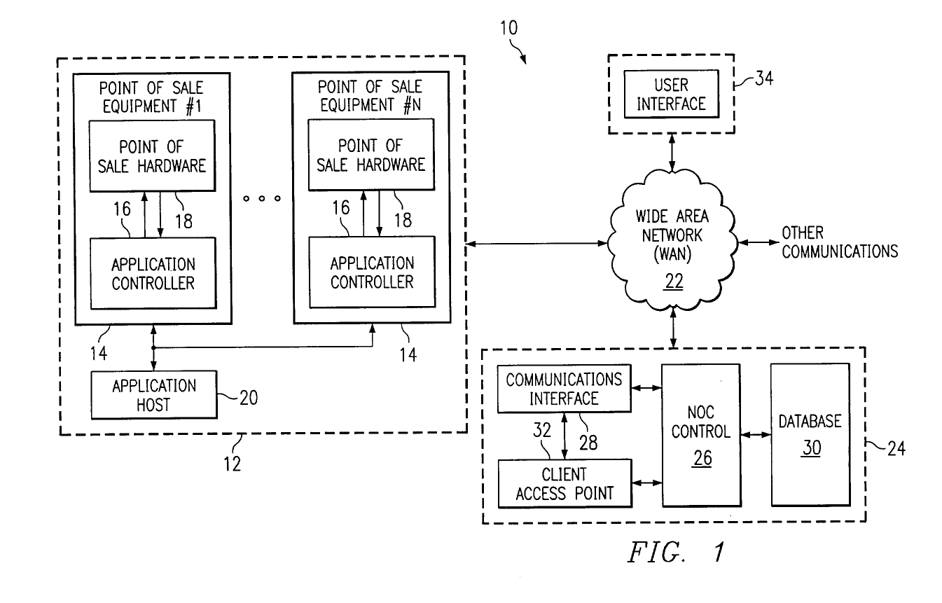

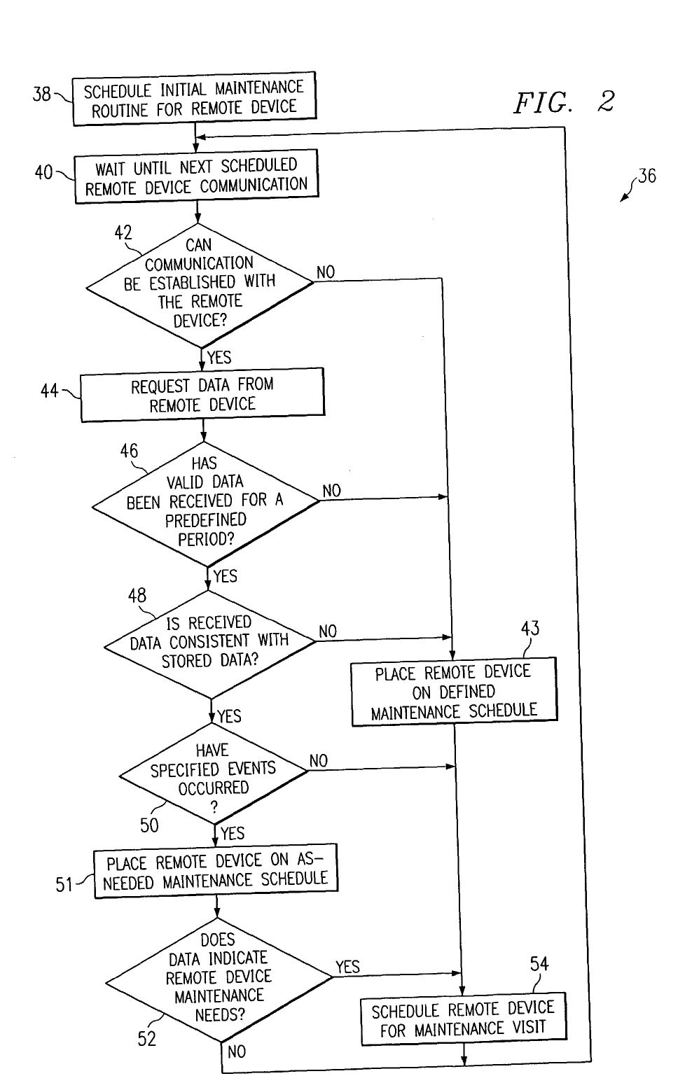

The preferred embodiment of the present invention and its advantages are best understood by referring to FIGS. 1 through 2 of the drawings, like numerals being used for like and corresponding parts of the various drawings.

FIG. 1 is a functional block diagram of one embodiment of a monitoring and maintenance scheduling system for distributed assets or devices, such as remote point of sale (POS) devices, remote dispensing devices and vending machines, according to teachings of the present invention. The terms “distributed assets” and “remote devices” are used in this application to mean any machine, device, system or equipment that may be remotely monitored in accordance with teachings of the present invention. Examples of such distributed assets include, but are not limited to, industrial machines, vending machines, ice machines and beverage dispensing equipment. In addition, according to teachings of the present invention, vending machines may be characterized as either point of sale devices, dispensing devices or both. However, vending machines, point of sale devices and dispensing devices do not necessarily refer to the same type of device when used herein.

In general, system 10 of FIG. 1 communicates information from a remote location or site 12 over a wide area wireless or wire-line network. Remote location or site 12 may include one or more remote devices such as point of sale device 14.

In an embodiment of the present invention directed to vending machine operations, each vending machine may include vending hardware and inventory for performing vending functions and electronically tracking some vending information. Vending machines may provide various types of products to customers such as soft drinks, snacks, newspapers, Internet access, phone cards, etc.

According to one aspect of the present invention, point of sale (POS) device 14 preferably includes an application controller 16 coupled to and interfacing with POS hardware 18. POS device 14 may also be equipped with electronics for controlling operations as well as tracking some events. In a vending machine environment, events tracked may include the denominations of monies received, change given, the number of vends from each slot as well as others. Application controllers 16 may also be configured to communicate with embedded electronics as well as equipped to directly sense other events and device or equipment parameters. In a multi-POS-device site 12, application controllers 16 may be enabled to communicate with one another and an application host 20 via onboard wire-line interfaces or wireless transceivers (not expressly shown) using wire-line or wireless transmissions respectively. Although the present invention discusses vending machines, other types of POS devices, dispensing devices or distributed assets are considered within the scope of the present invention.

In one embodiment, an application controllers 16 and application host 20 may be coupled together to form a LAN supported by the wire-line and/or wireless transmissions. In addition, application controllers 16 may also act as repeaters in an embodiment where application host 20 is not provided or is unable to directly communicate with a particular application controller 16 while another application controller 16, which does have an established communication link with application host 20, is able to directly communicate.

Application host 20, when employed, may be used to acquire data captured by application controllers 16 and to package and communicate that data across an external network 22 using a wide area network (WAN) interface. For example, in a vending machine environment, data which may be captured by application controllers 16 includes, but is not limited to, the amount of paper currency accepted, the amount and denominations of coins accepted, the amount and denominations of coins available in the remote devices charge fund as well as the number of vends by the remote device. The format typically employed for capturing and transmitted operational data or characteristics for a vending machine is the DEX (Direct Exchange) format. In alternate embodiments using POS devices, dispensing devices, industrial machines, ice machines, etc., other data formats may be employed.

Application host 20 may be installed together with application controller 16 inside POS device 14 or housed separately in another location. A WAN interface (not expressly shown) preferably included in application controller 20 may be implemented in one of a number of ways. In particular, the WAN interface of application controller 20 may be designed to support a wide area network 22 that can be implemented using wire-line or wireless transmissions.

As shown in FIG. 1, a network operations center (NOC) 24 may be provided to communicate with one or more device sites 12 across wide area network 22. In the embodiment of FIG. 1, network operations center 24 preferably includes a NOC control 26 operable to communicate with wide area network 22 through communications interface 28. According to teachings of the present invention, NOC control 26 can receive data acquired from and transmit data to device sites 12, process the data and store the data into a database 30. NOC control 26 may also be configured to perform instant alert paging, direct dial alarms and other functions to provide real time notification to a device operator upon the occurrence of certain events (e.g., not accepting money, out-of-change, inventory depletion, etc.). Communications interface 28, between NOC control 26 and the wide area network 22, may be implemented through the use of either wire-line or wireless transmissions.

At network operations center 24, a client access point 32 may be included to provide access from a client interface subsystem (CI) 34 across external network 22. In one implementation, client access point 32 can be a web-based interface allowing user access from a client computer across a network such as the Internet. Other implementations include providing a direct-dial connection between client interface subsystem 34 and client access point 32. Once connected, a user may use client interface subsystem 34 to obtain information from database 30 based upon data acquired from device sites 12. Further, users may be provided with extended services such as trend information developed by mining and analyzing database 30. According to the present invention, system 10 of FIG. 1 combines a number of technologies to provide technical advantages in the area of remote device management.

FIG. 2 is a flow diagram illustrating one embodiment of a method for transitioning maintenance scheduling of distributed assets or remote devices according to teachings of the present invention. Method 36 of FIG. 2 may be employed with a variety of communication enabled distributed assets such as point of sale devices, dispensing devices, vending machines of assorted types, pay telephones, industrial machines and others.

Beginning at 38, method 36 may begin with at least one remote device of a distributed asset system being deployed or setup with an initial maintenance routine or schedule. In a preferred embodiment of the present invention, the initial maintenance routine or schedule is an as-needed maintenance schedule. According to teachings of the present invention, as-needed maintenance scheduling involves scheduling maintenance for a device only when operational data, e.g., data included in a data file for the particular device, obtained from the device, such as remotely located POS device 14, indicates some malfunction, refill need, etc. In an embodiment of the present invention employed in a vending machine environment, the data file used is preferably in the DEX (direct exchange) format. Other data files for other machine or equipment types may also be employed. Alternative variations of as-needed maintenance scheduling are considered within the spirit and scope of the present invention.

According to teachings of the present invention, defined maintenance scheduling involves fixing the intervals between site 12 visits by technicians such that a remote device on a defined maintenance schedule will be visited by a device technician every three-days, week, month, etc. Alternative forms of defined maintenance scheduling are considered within the spirit and scope of the present invention.

After each POS device 14 such as a vending machine has been initiated onto its associated monitoring and maintenance scheduling network, method 36 preferably proceeds to step 40 where the next scheduled communication with the POS device 14 is awaited. Communications with remote POS devices 14 can be scheduled in a variety of ways and may depend on the specific needs of each distributed asset operator. For example, daily communications with each remotely monitored POS device 14 or a portion of the remotely monitored POS devices 14 in a distributed asset system may be appropriate while other POS devices 14 or other portions of the distributed asset systems may only need be communicated with weekly, monthly, etc.

Upon arrival of the time for a scheduled communication with a POS device 14, NOC 24 preferably attempts to establish a communications link, at 42, with the remote POS device 14 due to report or the POS device 14 being evaluated via WAN 22, for example. In the event that NOC 24 is unable to establish communications with the POS device 14 due to report its operational data, method 36 preferably proceeds to 43 where the maintenance schedule of the POS device 14 due to report is set to defined maintenance scheduling.

From 43, method 36 preferably proceeds to 54. At 54, a maintenance visit for the remote POS device 14 being evaluated is preferably scheduled. Once a maintenance visit has been scheduled or, in the event that the POS device 14 is not in need of maintenance, method 36 preferably proceeds to 40 where the time for the next remotely monitored POS device 14 due to report may be awaited.

In another embodiment of the present invention, the POS device 14 due to report may be configured to contact or establish communication with NOC 24 at its scheduled operational data reporting time. In such an embodiment, the remotely monitored POS device 14 due to report will preferably be responsible for establishing communication with NOC 24 and for communicating its operational data to NOC 24. In order to ensure the maintenancing of POS devices 14, NOC 24, in this embodiment, may maintain an expected communication time for each remotely monitored POS device 14 such that when a remotely monitored POS device 14 misses its scheduled communication time or fails to establish communication with NOC 24, NOC 24 is aware of the failure and can place the non-reporting POS device 14 on a defined maintenance schedule as described above.

Method 36 preferably proceeds to 44 once communications between NOC 24 and the remotely monitored POS device 14 due to report have been established. At 44, NOC 24 may request operational data from the remotely monitored POS device 14 due to report. The operational data requested by NOC 24 may include current operational data, historical operational data stored, for example, by the POS device 14 or some combination of historical and current operational data. In one embodiment of the present invention, particularly in the vending machine environment, the operational data requested by NOC 24 or transmitted by the POS device 14 due to report will typically be in the format of DEX data. As mentioned above, the data format employed may depend on the type of device, machine or equipment with which the present invention is employed.

According to teachings of the present invention, operational data may include such information as, in a vending machine environment, the number of functions performed by the remotely monitored POS device 14, the amount and denomination of monies accepted, vends of each item, hardware performance characteristics of the POS device 14, etc. Further, current operational data may include operational data for the last hour, day, week, month, etc. Similarly, the amount of operational data included in historical operational data may include the previous day's, three-day's, week's or some other predefined period's operational data.

In the embodiment of the present invention where the remotely monitored POS device 14 due to report is responsible for establishing communication with NOC 24, a request for operational data from NOC 24 may be unnecessary. In its place, the remotely monitored POS device 14 due to report may be configured to request permission to transmit its operational data to NOC 24 or to request a notification of receipt, by NOC 24, of its operational data transmission once transmission is complete. Similar modifications to method 36 are considered within the scope of the present invention.

Verification of receipt of operational data from the remotely monitored POS device 14 due to report may also be incorporated into method 36. For example, NOC 24 may be further configured to verify that any operational data transmissions received from POS devices 14 contain readable or complete data. In instances where NOC 24 receives a garbled or corrupt operational data transmission, method 36 may return to 44 such that NOC 24 may request another operational data transmission attempt from the remotely monitored POS device 14 due to report. Method 36 may also be implemented such that it repeats such a loop a fixed number of iterations before proceeding to 43 where the POS device 14 experiencing difficulty getting its current and/or historical operational data to NOC 24 is transitioned from its current maintenance schedule, e.g., as needed maintenance scheduling, to an alternate maintenance schedule, e.g., defined maintenance scheduling.

Once NOC 24 has received an operational data transmission from the POS device 14 due to report, method 36 preferably proceeds to 46 where the operational data may be evaluated. At 46, NOC 24 preferably performs one or more evaluations or tests on the operational data received to verify that the operational data received is valid. Testing of operational data from the POS device 14 due to report may include, but is not limited to, ensuring that the operational data received contains an identifier correlated with the POS device 14 due to report, ensuring that any segments of data expected in the operational data transmission are present, ensuring that a predefined period of operational data is valid, etc. If it is determined that the operational data received from the remotely monitored POS device 14 due to report is invalid, method 36 preferably proceeds to 43 where the POS device 14 transmitting the invalid operational data is placed on a defined maintenance schedule.

From 43, method 36 preferably proceeds to 54. At 54, a maintenance visit for the POS device 14 being evaluated is preferably scheduled. Once a maintenance visit has been scheduled or, in the event that the POS device 14 is not in need of maintenance, method 36 preferably proceeds to 40 where the time for the next remotely monitored POS device 14 due to report is awaited. If at 46 the operational data received by NOC 24 tests, or is successfully evaluated or verified as valid, method 36 preferably proceeds to 48.

At 48, the current and/or historical operational data received by NOC 24 is evaluated for consistency. In one embodiment, NOC 24 maintains historical operational data for each POS device 14 in database 30 or in a similar location. The operational data received by NOC 24 on the present occasion is preferably the POS device's 14 current operational data. Upon receipt of the remotely monitored POS device's 14 current operational data, NOC 24 preferably compares the current operational data to the remotely monitored POS device's 14 historical operational data to determine whether the operational data received is consistent. In a vending machine environment, one test for consistency may involve verifying that the current operational data does not indicate that the vending machine made more sales of a particular item than the historical operational data indicates the vending machine had in its inventory. Other methods of verifying consistency between historical and current operational data are considered within the scope of the present invention. In the event that the current operational data fails the verification for consistency performed at 48, method 36 preferably proceeds to 43 where the POS device 14 is placed on a defined maintenance schedule.

From 43, method 36 preferably proceeds to 54. At 54, a maintenance visit for the remote POS device 14 being evaluated is preferably scheduled. Once a maintenance visit has been scheduled or in the event that the POS device 14 is not in need of maintenance, method 36 preferably proceeds to 40 where the time for the next remotely monitored POS device 14 due to report is awaited. If the current operational data received from the remotely monitored POS device 14 due to report passes the verification for consistency performed at 48, method 36 preferably proceeds to 50.

At 50, the operational data for the remotely monitored POS device 14 due to report is preferably parsed and read for its contents. NOC 24 preferably reads the operational data for the remotely monitored POS device 14 due to report to determine whether one or more triggering events have occurred. In examining whether one or more triggering events have occurred, NOC 24 may examine only current operational data, only historical operational data or a combination of current and historical operational data. In a vending machine environment, for example, triggering events may include, but are not limited to, such events as refill events, certain dollar amounts of sales, etc. Alternative triggering events may also be used without departing from the spirit and scope of the present invention.

In the event that the occurrence of desired triggering events at the remotely monitored POS device 14 are not detected in the device's operational data, method 36 preferably proceeds to 43 where the POS device 14 is placed on a defined maintenance schedule.

From 43, method 36 preferably proceeds to 54. At 54, a maintenance visit for the POS device 14 under evaluation is preferably scheduled. Once a maintenance visit has been scheduled or in the event that the POS device 14 is not in need of maintenance, method 36 preferably proceeds to 40 where the time for the next remotely monitored POS device 14 due to report is awaited. If at 50, a review of the operational data for the remotely monitored POS device 14 due to report indicates that the desired triggering events have occurred, method 36 preferably proceeds to 51.

At 51, method 36 preferably updates the maintenance scheduling for the remotely monitored POS device 14 due to report. If the POS device 14 due to report is currently on a defined maintenance schedule, the maintenance schedule for the POS device 14 may be changed to as-needed maintenance scheduling. If the POS device 14 is currently on an as-needed maintenance schedule, method 36 preferably verifies the POS device's 14 as-needed maintenance scheduling at 51 and then proceeds to 52.

In the embodiment of the present invention illustrated in FIG. 2, for a POS device 14 to transition from a defined maintenance schedule to an as-needed maintenance schedule or for a remote POS device 14 to remain on an as-needed maintenance schedule, the operational data for the remote POS device 14 preferably passes both the validity and consistency verifications as well as shows the occurrence of one or more triggering events. However, alternative embodiments of method 36 are considered within the spirit and scope of the present invention. For example, a remotely monitored POS device 14 may be transitioned from defined maintenance scheduling to as-needed scheduling so long as the operational data for the remotely monitored POS device 14 is verified to be valid and consistent within a specified range.

Once a remotely monitored POS device's 14 maintenance schedule has been transitioned or updated to an as-needed maintenance schedule at 51, method 36 preferably proceeds to 52. At 52, the operational data for the remotely monitored POS device 14 under review is preferably evaluated to determine whether the operational data indicates any maintenance needs by the remote POS device 14. For example, in a vending machine environment, the operational data for the remote POS device 14 under review may indicate low inventory levels for one or more items. In the event that the operational data for a remotely monitored POS device 14 under evaluation indicates a maintenance need, method 36 preferably proceeds to 54. At 54, a maintenance visit for the remote POS device 14 under evaluation is preferably scheduled. Once a maintenance visit has been scheduled or in the event that the remote POS device 14 is not in need of maintenance, method 36 preferably proceeds to 40 where the time for the next remotely monitored POS device 14 due to report is awaited.

Although the present invention has been described with respect to a specific preferred embodiment thereof, various changes and modifications may be suggested to one skilled in the art, for example, transitioning between more than two maintenance schedules. Accordingly, it is intended that the present invention encompass such changes and any such modifications fall within the scope of the appended claims.

What is claimed is:

1. A method for transitioning a maintenance schedule for a remotely monitored device between as-needed maintenance scheduling and defined maintenance scheduling comprising:
maintaining historical operational data for the remotely monitored device;
verifying receipt of valid operational data for the remotely monitored device;
verifying current operational data is consistent with a predefined period of historical operational data;
examining the current operational data and the historical operational data to detect an occurrence of at least one triggering event;
determining whether the triggering event indicates a failure in verification;
transitioning from as-needed maintenance scheduling to defined maintenance scheduling in response to the triggering event indicating failure in verification; and
transitioning from defined maintenance scheduling to as-needed maintenance scheduling in response to failing to detect at least one triggering event after as-needed maintenance has been performed.

2. The method of claim 1 further comprising:
requesting operational data from the remotely monitored device; and
transitioning from as-needed maintenance scheduling to defined maintenance scheduling in response to a failure in fulfillment of the operational data request.

3. The method of claim 1 further comprising the triggering event including a vending machine refill event.

4. The method of claim 1 wherein the operational data further comprises DEX data.

5. The method of claim 1 further comprising scheduling the remotely monitored device for maintenance according to a defined maintenance schedule in response to failed communications between the remotely monitored device and a network operations center.

6. The method of claim 1 further comprising the remotely monitored device comprising point of sale hardware.

7. The method of claim 1 further comprising transitioning the remotely monitored device to defined maintenance scheduling in response to receipt of invalid operational data.

8. The method of claim 1 further comprising transitioning the remotely monitored device from defined maintenance scheduling to as-needed maintenance scheduling in response to receipt of valid operational data, consistent operational data and at least two refill events from the remotely monitored device.

9. A system for scheduling maintenance of remote devices comprising:
a wide area network;
at least one remote device operably coupled to the wide area network;
a network operations center operably coupled to the wide area network and operable to monitor the at least one remote device via the wide area network;
the at least one remote device operable to communicate operational data to the network operations center;
the network operations center operable to place the remote device on a defined maintenance schedule in response to a determination that current and historical operational data for the remote device are not consistent and that the current operational data for the remote device may be invalid; and
the network operations center operable to place the remote device on an as-needed maintenance schedule in response to a determination that the current and historical operational data for the remote device is consistent and that the current operational data for the remote device is valid.

10. The system of claim 9 further comprising:
the network operations center operable to evaluate the current operational data and the historical operational data to determine whether at least one triggering event has occurred; and
the network operations center operable to schedule the remote device for a maintenance visit in response to an absence of at least one triggering event.

11. The system of claim 10 further comprising:
the network operations center operable to place the remote device on a defined maintenance schedule in response to inconsistent current and historical operational data, invalid current operational data and the absence of at least one triggering event; and
the network operations center operable to place the remote device on an as-needed maintenance schedule in response to consistent current and historical operational data, valid current operational data and the occurrence of at least one triggering event.

12. The system of claim 9 further comprising the network operations center operable to place the remote device on a defined maintenance schedule in response to a failure by the network operations center to establish communications with the remote device.

13. The system of claim 12 further comprising the network operations center operable to schedule the remote device for a maintenance visit in response to a determination that at least one triggering event has not occurred.

14. The system of claim 9 further comprising the remote device including vending hardware.

15. A method for ensuring the maintenance scheduling of remotely located point of sale devices comprising:
identifying a current maintenance schedule for a remotely located point of sale device;
examining a data file including information indicative of a current operating status of the remotely located point of sale device to verify validity of the data file, consistency of the current operating status with a history of the remotely located point of sale device's operating characteristics and to identify at least one triggering event;
transitioning, if the current maintenance schedule for the remotely located point of sale device is an as-needed maintenance schedule, the remotely located point of sale device from the as-needed maintenance schedule to a defined maintenance schedule in response to a failure in verification of the data file;
transitioning, if the current maintenance schedule for the remotely located point of sale device is an as-needed maintenance schedule, the remotely located point of sale device from the as-needed maintenance schedule to a defined maintenance schedule in response to a failure in identification of at least one triggering event in the data file; and
transitioning, if the current maintenance schedule for the remotely located point of sale device is a defined maintenance schedule, to an as-needed maintenance schedule in response to verification of data file validity and consistency and identification of at least one triggering event.

16. The method of claim 15 further comprising maintaining the remotely located point of sale device on the as-needed maintenance schedule in response to verification of data file validity, data file consistency and identification of at least one triggering event.

17. The method of claim 15 further comprising examining the data file to determine whether the remotely located point of sale device requires maintenance.

18. The method of claim 15 further comprising transitioning, if the current maintenance schedule for the remotely located point of sale device is an as-needed maintenance schedule, the remotely located point of sale device to a defined maintenance schedule in response to an inability to communicate between a network operations center and the remotely located point of sale device.

19. The method of claim 15 further comprising examining the data file including information indicative of a current operating status of the remotely located point of sale device to verify that a valid data file has been received for a predefined period of time, that consistency between the current operating status and the remotely located point of sale device's history exists for a predefined period of time and to identify an occurrence of at least one refill event.

20. The method of claim 15 further comprising the remotely located point of sale device including a vending machine.
